(19) United States
(12) Patent Application Publication
(10) Pub. No.: US 2017/0199733 A1
(43) Pub. Date: Jul. 13, 2017

(54) METHOD FOR TERMINAL TO UPDATE OPERATING SYSTEM, TERMINAL AND SYSTEM

(71) Applicant: GIONEE COMMUNICATION EQUIPMENT CO.,LTD. SHENZHEN, Shenzhen (CN)

(72) Inventors: Litong LI, Shenzhen (CN); Yanyi WANG, Shenzhen (CN)

(73) Assignee: GIONEE COMMUNICATION EQUIPMENT CO.,LTD. SHENZHEN, Shenzhen (CN)

(21) Appl. No.: 15/326,623

(22) PCT Filed: Dec. 19, 2014
(86) PCT No.: PCT/CN2014/093336

§ 371 Date: Jan. 16, 2017

(30) Foreign Application Priority Data
Jul. 15, 2014 (CN) 201410337404.X
Jul. 15, 2014 (CN) 201410337407.3

(51) Int. Cl. G06F 9/445; H04L 29/08; H04L 12/24

(52) U.S. Cl. CPC G06F 8/65; H04L 41/082; H04L 67/34; H04L 67/36; G06F 8/62

(57) ABSTRACT

Provided is a method for a terminal to update an operating system, including: acquiring a terminal identifier that needs to update an operating system; updating a first operating system corresponding to the terminal identifier on a server according to system update information; and sending an update result of the first operating system to a terminal corresponding to the terminal identifier, so that a second operating system of the terminal displays the update result. The embodiments of the present invention enable a terminal to update an operating system in time, and can improve the update efficiency of the terminal, improve the security and stability of the operating system of the terminal, reduce the time cost to update the terminal by a user and improve user experience.

### CROSS REFERENCE TO RELATED APPLICATIONS

This application claims the benefit of priority to Chinese Patent Application No. 201410337404.X, filed on Jul. 15, 2014 with the Patent Office of the People's Republic of China, and entitled “METHOD AND DEVICE FOR UPDATING OPERATION SYSTEMS FOR TERMINAL” and Chinese Patent Application No. 201410337407.3, filed on Jul. 15, 2014 with the Patent Office of the People's Republic of China, and entitled “METHOD, DEVICE AND SYSTEM FOR UPDATING TERMINAL OPERATING SYSTEMS”, which disclosures are herein incorporated by reference.

### TECHNICAL HELD

The present disclosure relates to the field of electronic technology, and particularly to a method for terminal to update operating system, terminal and system.

### BACKGROUND

Smart phones and other terminals all provided with an operating system, and the operating system usually contains some system software. When system vulnerabilities have occurred or there is a need to optimize the system software, system developers will release a new version of the operating system to address the system vulnerabilities or upgrade the system software. After the system developers released the new version of the operating system, users must actively download data of the new version of the operating system and update the terminal, such a system update approach consumes much of time and effort of users.

### SUMMARY

According to embodiments of the present disclosure, a method for a terminal to update an operating system and an apparatus are provided, which can enable the terminal to update the operating system in time, and can improve the update efficiency of the terminal, improve the security and stability of the operating system of the terminal, reduce the time cost to update the terminal by user and improve user experience.

According to an embodiment of the present disclosure, a method for a terminal to update an operating system is provided, which includes: acquiring a terminal identifier that needs to update an operating system; updating a first operating system corresponding to the terminal identifier on a server according to system update information; and sending an update result of the first operating system to a terminal corresponding to the terminal identifier, so that a second operating system of the terminal displays the update result.

Accordingly, according to an embodiment of the present disclosure, a server is provided, which includes: an acquiring unit, configured to acquire a terminal identifier that needs to update an operating system; an updating unit, configured to update a first operating system corresponding to the terminal identifier on a server according to system update information; and a sending unit, configured to send an update result of the first operating system to a terminal corresponding to the terminal identifier, so that a second operating system of the terminal displays the update result.

According to an embodiment of the present disclosure, a method for a terminal to update an operating system is provided, which includes: receiving an update result from a server, and the update result is generated after the server has updated a first operating system corresponding to a terminal identifier of a terminal; and displaying the update result on a second operating system of the terminal.

Accordingly, according to an embodiment of the present disclosure, a terminal is provided, which includes: a receiving unit, configured to receive an update result from a server, and the update result is generated after the server has updated a first operating system corresponding to a terminal identifier of a terminal; and a displaying unit, configured to display the update result on a second operating system of the terminal.

Correspondingly, according to an embodiment of the present disclosure, a system is provided, which includes a server and a terminal, the server can be the aforementioned server, and the terminal can be the aforementioned terminal.

In the embodiments of the present disclosure, by updating a first operating system at a server, and displaying an update result on a second operating system of a terminal, the terminal can be updated, whereby the terminal can be enabled to update the operating system in time, and the update efficiency of the terminal can be improved, the security and stability of the operating system of the terminal can be improved, the time cost to update the terminal by user can be reduced and user experience can be improved.

### BRIEF DESCRIPTION OF THE DRAWINGS

In order to more clearly illustrate the technical solutions of the embodiments of the present disclosure, reference will now be made to the accompanying drawings which are required to be used in the embodiments; it will be apparent that the drawings described below are some embodiments of the present disclosure, and for those skilled in the art, other drawings may also be obtained from the drawings without creative effort being made.

FIG. 1 is a flow chart diagram illustrating a method for a terminal to update an operating system;

FIG. 2a is a first structural diagram illustrating a server according to an embodiment of the present disclosure;

FIG. 2b is a second structural diagram illustrating the server according to an embodiment of the present disclosure;

FIG. 2c is a third structural diagram illustrating the server according to an embodiment of the present disclosure;

FIG. 2d is a fourth structural diagram illustrating the server according to an embodiment of the present disclosure;

FIG. 3 is a flow chart diagram illustrating a method for a terminal to update an operating system;

FIG. 4a is a first structural diagram illustrating a terminal according to an embodiment of the present disclosure;

FIG. 4b is a second structural diagram illustrating the terminal according to an embodiment of the present disclosure;

FIG. 4c is a third structural diagram illustrating the terminal according to an embodiment of the present disclosure;

FIG. 5 is a structural diagram illustrating a system according to an embodiment of the present disclosure;

FIG. 6 is a flow chart diagram illustrating a first embodiment of the system according to an embodiment of the present disclosure.

FIG. 7 is a structural diagram illustrating another server according to an embodiment of the present disclosure; and

FIG. 8 is a structural diagram illustrating another terminal according to an embodiment of the present disclosure.

### DETAILED DESCRIPTION OF ILLUSTRATED EMBODIMENTS

Technical solutions of the embodiments of the present disclosure will be described clearly and completely hereinafter with reference to the accompanying drawings in the embodiments of the present disclosure, obviously, the described embodiments are a part of the embodiments of the present disclosure, rather than all of the embodiments. On the basis of the embodiments of the present disclosure, all other embodiments obtained by those of ordinary skill in the art without making creative work are within the scope of protection of the present disclosure.

According to an embodiment of the present disclosure, it is provided a method for a terminal to update an operating system, which can include: acquiring a terminal identifier that needs to update an operating system; updating a first operating system corresponding to the terminal identifier on a server according to system update information; and sending an update result of the first operating system to a terminal corresponding to the terminal identifier, so that a second operating system of the terminal displays the update result. The method of the embodiment of the present disclosure can enable the terminal to update the operating system in time, and can improve the update efficiency of the terminal, improve the security and stability of the operating system of the terminal, reduce the time cost to update the terminal by user and improve user experience.

In the following, the technical solutions of the present disclosure will be described in detail with reference to the accompanying drawings and specific embodiments.

As illustrated in FIG. 1, the method for a terminal to update an operating system according to an embodiment of the present disclosure can include the follows:

S110, a terminal identifier that needs to update an operating system is acquired;

S111, a first operating system corresponding to the terminal identifier on a server is updated according to system update information; and

S112, an update result of the first operating system is sent to a terminal corresponding to the terminal identifier, so that a second operating system of the terminal displays the update result.

In the embodiment of the present disclosure, the terminal used by user is improved and the server for maintaining the terminal is also improved, therefore, the terminal can keep the best update state without an upgrading package. In a specific implementation, in the method of the embodiment of the present disclosure, the server is provided with multiple subsystems corresponding to the operating system of the terminal, that is, the first operating system arranged on the server corresponds to the second operating system of the terminal.

Further, the first operating system on the server contains complete applications of all kinds of software and various factory default software, which is configured to receive data transmitted by the terminal, execute instructions, and provide background services for the terminal. The second operating system on the terminal used by user is a simple operating system, and is configured to carry out data interaction with the server; the second operating system includes drivers of terminal hardware and cache and is used as user equipment, and is configured to transmit operation contents and operation instructions of the user to the server, request the server to support to execute the operation instructions or synchronize the operation contents. Connections between the server and the terminal are usually network connections, such as the Internet, local area network, and the like.

In a specific implementation, after the maintenance staff has improved the operating mode of the terminal according to user feedback on the terminal as well as self-test instruction execution efficiency, maintenance operations of the system will be reflected in the first operating system of the server, that is, system data and application data in the first operating system of the server will be maintained and updated, finally, the result of the maintenance and upgrade is sent to the terminal for display to the user, for example, the user can directly see the improvement of the icon, the page optimization and indirectly feel the effect of increasing the rate of reaction progress. Since the update result is pushed to the terminal, the terminal does not need to install an upgrade package and the like, and the improvement effect as a result of upgrading the first operating system by the server can be reflected in the second operating system of the terminal, therefore, compared with the related art, the technical solution of the embodiment of the present disclosure can greatly reduce the consumption of network traffic, solve problems that the terminal memory is occupied and the system cannot be upgraded in a timely manner, and improve the operating stability of the first operating system and the second operating system, users can experience the upgraded system immediately and directly through the terminal.

In a specific implementation, the terminal always keep in sync with the second operating system on the server in terms of software and display; when the user add/delete applications to the terminal, use the application, or modify the terminal display, the terminal can feed back the operation contents of the user to the server, whereby the first operating system of the server can make corresponding changes synchronously. When the server upgrades the first operating system, interface improvements of the first operating system can be synchronized to the terminal. Besides, applications that run on the first operating system on the server and interface display are based on the status before the terminal is shut down.

In a specific implementation, the terminal identifier can be a unique identifier, such as machine serial number, Media Access Control (MAC) address, or an account registered in the system; when the terminal needs to send information to the server, the information sent can carry the terminal identifier for the server to record and categorize; when the server needs to detect whether the terminal needs to be upgraded, the server can find the first operating system corresponding to the terminal through the terminal identifier recorded.

Optionally, the server according to the embodiment of the present disclosure can be configured to receive an execution instruction sent from the terminal, and the execution instruction is generated by the terminal according to operation contents of the user on the terminal: the execution instruction is received from the terminal, among which the execution instruction is an instruction generated by the terminal according to operation contents of the user on the terminal, and the operation contents includes invoking software in the second operating system; the execution instruction is executed on the first operating system; an execution result of the first operating system is sent to the terminal, so that a second operating system of the terminal can display the execution result.

In a specific implementation, the execution instruction sent by the terminal can be generated according to a page entry instruction, searching keywords based on the browser, and other user operations; at this point, after the execution instruction is sent to the server by the terminal, the server can cause the first operating system to execute the execution instruction, and return an execution result (for example, the page entered, search results) to the terminal for display to the user through a second operating system.

Optionally, the above-mentioned execution instruction can carry pending data (in other words, data to be processed) and a software identifier of software required to be invoked to process the pending data, among which the pending data can include data collected by a hardware device of the terminal; the process that the server executes the execution instruction in the first operating system can include: the pending data is acquired; software corresponding to the software identifier of the first operating system is used to process the pending data, and process result data is generated; the process result data is sent to the terminal, so that the terminal can display the result data in the second operating system.

In a specific implementation, the execution instruction can carry pending data, for example, a manufacture-provided photographic application; when the icon of the photographic application on the terminal is clicked by user, the terminal can initiate a hardware invoking program to cause a camera to take pictures, after the photographing is completed, a photograph processing command carrying shooting data is transmitted to the server, such that the first operating system of the server can process the shooting data, generate image data for display, and sent the image data to the terminal, whereby the terminal can display the image data. In the execution of the execution instruction, the main body that is actually used to execute the execution instruction is the server, therefore, even if a large number of calculation contents is involved, it will not take up the memory of the terminal, pauses will not occur during the execution of this execution instruction. The pending data carried in the execution instruction of the present embodiment is not limited to the shooting data, it can also be some gravity sensing data, infrared Bluetooth frequency data, and so on, and the present disclosure is not limited thereto.

Optionally, the server according to the embodiment of the present disclosure is further configured to install a corresponding application on the first operating system according to a software install request sent by the terminal, so as to support the terminal to provide the user with the corresponding application: a software install request is received from the terminal; software to be installed as indicated by the software install request is acquired; the software to be installed is installed in the first operating system corresponding to the terminal identifier; an installation result of the first operating system is transmitted to the terminal, so that the terminal can display the installation result on the second operating system.

In a specific implementation, according to the operation contents of the user, when it is needed to provide more applications to the user, the terminal can send the software install request to the server, whereby the server can obtain data of the software to be installed and install the same of the first operating system; at the end, the installation result (such as a new icon, a page entered by clicking the icon, and so on) after software installation is sent to the terminal for display. When the user uses the installed software, the terminal can send the operation contents of the user based on the software to the server for process. As can be seen, the installation is actually performed by the server and the storage location of the installer is the server either, thus, the operation contents of installing software by user will not take up the memory of the terminal, and therefore, it will not slow down the speed of the terminal.

In a specific implementation, when the new software is installed by the first operating system, the terminal should have a new software icon appears in the terminal interface, and the display location of the new software icon can be specified by the first operating system or can be pre-determined by the second operating system; if the display location of the new icon is pre-determined by the second operating system before the software install request is submitted by the terminal, the display location of the new software icon can be submitted to the server along with the software install request by the terminal, whereby the new software icon can be placed at a specified location by the second operating system after the software is installed successfully.

Optionally, the server according to the embodiment of the present disclosure can be further configured to uninstall a corresponding application on the first operating system according to a software uninstall request sent by the terminal, at this point, this corresponding application will not be provided at the terminal any more: a software uninstall request carrying the identifier of the software to be uninstalled is received from the terminal; the software to be uninstalled corresponding to the identifier is uninstalled from the first operating system corresponding to the terminal identifier in the server; an uninstall result of the first operating system is sent to the terminal, so that the second operating system of the terminal can display the uninstall result.

In a specific implementation, when some application or software is no longer needed, the terminal can perform a delete operation on the terminal; however, software uninstall, cache data removal is finally performed in the first operating system in the server. After the software is uninstalled in the first operating system, the server can send an uninstall result to the terminal, as a consequence, the uninstall result displayed in the second operating system is that the software icon of the uninstalled software will no longer appear.

Optionally, during the shutdown process of the terminal, the server is also configured to store the terminal information synchronized from the terminal, so as to ensure the security of the terminal information: terminal information is received from the terminal, among which the terminal information includes the terminal identifier and information of the second operating system of the terminal, and the terminal information is sent by the terminal during the shutdown process; and the first operating system on the server is updated according to the terminal information.

In a specific implementation, the terminal information sent to the server can include the terminal identifier, a list of all software on the second operating system, and the current display effect; the server will synchronize the terminal information to the first operating system.

In the technical solution of the present disclosure, system or software problems can be user feedback to manufacturers based on user experience, or it can also be found by monitoring the operating efficiency of the first operating system and the second operating system. When a problem is identified, manufactures can perform real-time remediation with regard to this problem via a specified interface, or, when a new operating system is released for the terminal, the server can upgrade the first operating system according to the new operating system, thereafter, send an upgrade result to the terminal so as to display through the second operating system. Besides, if the first operating system itself has an upgrade event or the software in the first operating system has an upgrade event, when the update result is sent, or when the terminal first connects to the server after a system upgrade, the user can be prompted that the current terminal has been updated, and the updated items will be shown clearly.

The method of the embodiment of the present disclosure improves user experience and makes it easy and convenient for the user to upgrade the terminal operating system; in particular, for mobile terminals commonly used by users, the method according to the embodiment of the present disclosure achieves the effect of saving traffic, saving updating time, and updating the operating system in time. The embodiment of the present disclosure improves the update scheme of the terminal so that the terminal can always update the operating system data in time, therefore, it can improve the operating system data update efficiency of the terminal, improve the operating system security and stability of the terminal, reduce the time cost of users, and improve user experience.

Correspondingly, according to an embodiment of the present disclosure, a server is provided for carry out the method for a terminal to update an operating system. The server can include: an acquiring unit, configured to acquire a terminal identifier that needs to update an operating system; an updating unit, configured to update a first operating system corresponding to the terminal identifier on a server according to system update information; and a sending unit, configured to send an update result of the first operating system to a terminal corresponding to the terminal identifier, so that a second operating system of the terminal displays the update result. The embodiment of the present disclosure can improve the update efficiency of operating system of the terminal, and improve the security and stability of the operating system of the terminal.

In the following, the technical solutions of the present disclosure will be described in detail with reference to the accompanying drawings and specific embodiments.

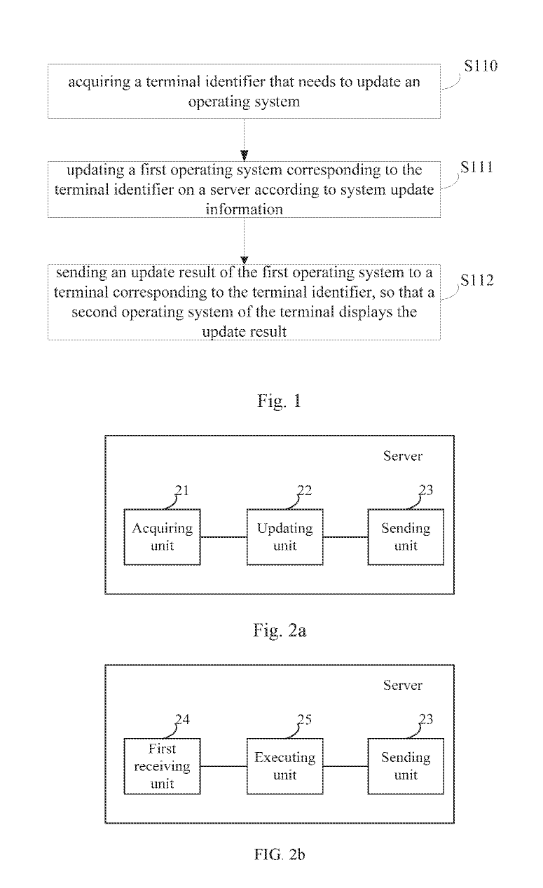

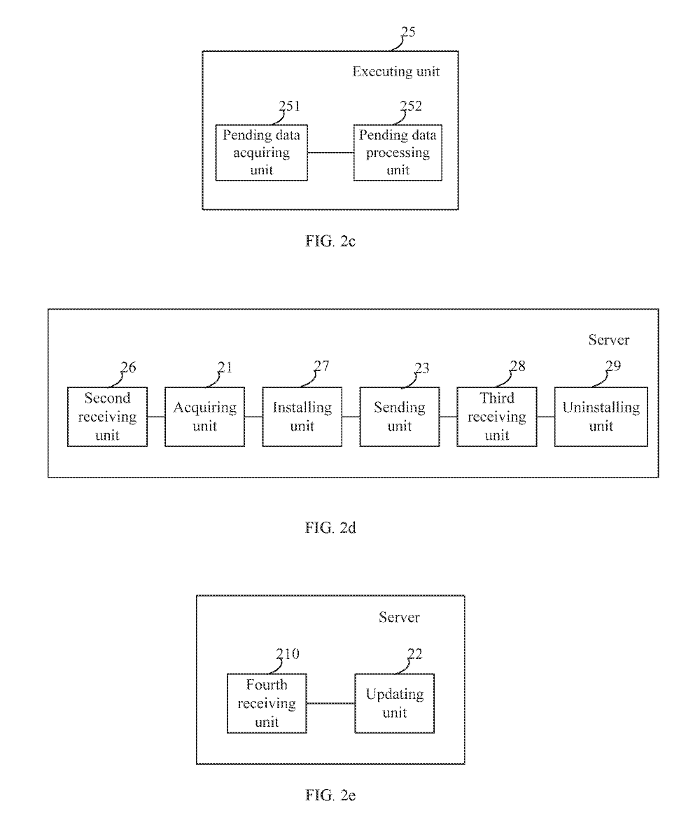

FIG. 2a is a structural diagram illustrating a server according to an embodiment of the present disclosure. The server of the embodiment can be used to implement the method of FIG. 1, and includes an acquiring unit 21, an updating unit 22, and a sending unit 23; reference is also made to FIG. 2b, FIG. 2c, FIG. 2d, and FIG. 2e, and the server can further include a first receiving unit 24, an executing unit 25, a second receiving unit 26, an installing unit 27, a third receiving unit 28, an uninstalling unit 29, and a fourth receiving unit 210, among which the executing unit 25 can further include a pending data acquiring unit 251 and a pending data processing unit 252.

The acquiring unit 21 is configured to acquire a terminal identifier that needs to update an operating system; the updating unit 22 is configured to update a first operating system corresponding to the terminal identifier on a server according to system update information; and the sending unit 23 is configured to send an update result of the first operating system to a terminal corresponding to the terminal identifier, so that a second operating system of the terminal can display the update result.

The server of the embodiment of the present disclosure can support the maintenance of the terminal, and the terminal can keep the best update state without an upgrading package. In a specific implementation, in the server of the embodiment of the present disclosure, the server is provided with multiple subsystems corresponding to the operating system of the terminal, that is, the first operating system arranged on the server corresponds to the second operating system of the terminal.

Further, the first operating system on the server according to the embodiment of the present disclosure contains complete applications of all kinds of software and various factory default software, which is configured to receive data transmitted by the terminal, execute instructions, and provide background services for the terminal. The second operating system on the terminal used by user is a simple operating system, and is configured to carry out data interaction with the server; the second operating system includes drivers of terminal hardware and cache and is used as user equipment, and is configured to transmit operation contents and operation instructions of the user to the server, request the server to support to execute the operation instructions or synchronize the operation contents. Connections between the server and the terminal are usually network connections, such as the Internet, local area network, and the like.

In a specific implementation, after the maintenance staff has improved the operating mode of the terminal according to user feedback on the terminal as well as self-test instruction execution efficiency, maintenance operations of the system will be reflected in the first operating system of the server according to the embodiment of the present disclosure, that is, system data and application data in the first operating system of the server will be maintained and updated, finally, the result of the maintenance and upgrade is sent to the terminal for display to the user, for example, the user can directly see the improvement of the icon, the page optimization and indirectly feel the effect of increasing the rate of reaction progress. Since the update result is pushed to the terminal, the terminal does not need to install an upgrade package and the like, and the improvement effect as a result of upgrading the first operating system by the server can be reflected in the second operating system of the terminal, therefore, compared with the related art, the technical solution of the embodiment of the present disclosure can greatly reduce the consumption of network traffic, solve problems that the terminal memory is occupied and the system cannot be upgraded in a timely manner, and improve the operating stability of the first operating system and the second operating system, users can experience the upgraded system immediately and directly through the terminal.

In a specific implementation, the terminal used in this embodiment can always keep in sync with the second operating system on the server in terms of software and display; when the user add/delete applications to the terminal, use the application, or modify the terminal display, the terminal can feed back the operation contents of the user to the server, whereby the first operating system of the server can make corresponding changes synchronously. When the server upgrades the first operating system, interface improvements of the first operating system can be synchronized to the terminal. Besides, applications that run on the first operating system on the server and interface display are based on the status before the terminal is shut down.

In a specific implementation, the terminal identifier can be a unique identifier, such as machine serial number, Media Access Control (MAC) address, or an account registered in the system; when the terminal needs to send information to the server, the information sent can carry the terminal identifier for the server to record and categorize; when the server of the embodiment of the present disclosure needs to detect whether the terminal needs to be upgraded, the server can find the first operating system corresponding to the terminal through the terminal identifier recorded.

Optionally, reference is also made to FIG. 2b; the server of the embodiment of the present disclosure can further include the first receiving unit 24, the executing unit 25, and the sending unit 23.

The first receiving unit 24 is configured to receive an execution instruction from the terminal, among which the execution instruction is an instruction generated by the terminal according to operation contents of the user on the terminal, and the operation contents includes invoking software in the second operating system; the executing unit 25 is configured to execute the execution instruction on the first operating system; the sending unit 23 is configured to send an execution result of the first operating system to the terminal, so that a second operating system of the terminal can display the execution result.

In a specific implementation, he execution instruction sent by the terminal can be generated according to a page entry instruction, searching keywords based on the browser, and other user operations; at this point, after the execution instruction is received by the first receiving unit 24, the executing unit 25 can execute the execution instruction, and the sending unit 23 can return an execution result (for example, the page entered, search results) to the terminal for display to the user through a second operating system.

Optionally, reference is also made to FIG. 2c, in the server of the embodiment of the present disclosure, the above-mentioned execution instruction can carry pending data (in other words, data to be processed) and a software identifier of software required to be invoked to process the pending data, among which the pending data can include data collected by a hardware device of the terminal; the executing unit 25 can further include the pending data acquiring unit 251 and the pending data processing unit 252.

The pending data acquiring unit 251 is configured to acquire the pending data, and the execution instruction carries pending data and a software identifier of software required to be invoked to process the pending data, among which the pending data can include data collected by a hardware device of the terminal.

The pending data processing unit 252 is configured to process the pending data by software corresponding to the software identifier of the first operating system, and generate process result data.

The sending unit 23 is further configured to send the process result data to the terminal, so that the terminal can display the result data in the second operating system.

In a specific implementation, the execution instruction can carry pending data, for example, a manufacture-provided photographic application; when the icon of the photographic application on the terminal is clicked by user, the terminal can initiate a hardware invoking program to cause a camera to take pictures, after the photographing is completed, the pending data acquiring unit 251 will receive a photograph processing command carrying shooting data, and the pending data processing unit 252 will process the shooting data and generate image data for display, the image data will be transmitted to the terminal for display by the sending unit 23. In the execution of the execution instruction, the main body that is actually used to execute the execution instruction is the server, therefore, even if a large number of calculation contents is involved, it will not take up the memory of the terminal, pauses will not occur during the execution of this execution instruction. The pending data carried in the execution instruction of the present embodiment is not limited to the shooting data, it can also be some gravity sensing data, infrared Bluetooth frequency data, and so on, and the present disclosure is not limited thereto.

Optionally, reference is also made to FIG. 2d, the server of the embodiment of the present disclosure can further include the second receiving unit 26, the installing unit 27, the third receiving unit 28, and the uninstalling unit 29, and is configured to install a corresponding application on the first operating system according to a software install request sent by the terminal, so as to support the terminal to provide the user with the corresponding application.

The second receiving unit 26 is configured to receive the software install request from the terminal; the acquiring unit 21 is further configured to acquire software to be installed as indicated by the software install request; the installing unit 27 is configured to install the software to the installed in the first operating system corresponding to the terminal identifier; the sending unit 23 is further configured to send an installation result of the first operating system to the terminal, so that the terminal can display the installation result on the second operating system thereof.

Alternatively, the third receiving unit 28 can be further configured to receive a software uninstall request carrying the identifier of the software to be uninstalled from the terminal; the uninstalling unit 29 is configured to uninstall the software to be uninstalled corresponding to the identifier from the first operating system corresponding to the terminal identifier in the server; and the sending unit 23 is further configured to send an uninstall result of the first operating system to the terminal, so that the second operating system of the terminal can display the uninstall result.

In a specific implementation, according to the operation contents of the user, when it is needed to provide more applications to the user, the terminal can send the software install request to the server, whereby the server can obtain data of the software to be installed and install the same of the first operating system; at the end, the installation result (such as a new icon, a page entered by clicking the icon, and so on) after software installation is sent to the terminal for display. When the user uses the installed software, the terminal can send the operation contents of the user based on the software to the server for process. As can be seen, the installation is actually performed by the server and the storage location of the installer is the server either, thus, the operation contents of installing software by user will not take up the memory of the terminal, and therefore, it will not slow down the speed of the terminal.

In a specific implementation, when the new software is installed by the first operating system, the terminal should have a new software icon appears in the terminal interface, and the display location of the new software icon can be specified by the first operating system or can be pre-determined by the second operating system; if the display location of the new icon is pre-determined by the second operating system before the software install request is submitted by the terminal, the display location of the new software icon can be submitted to the server along with the software install request by the terminal, whereby the new software icon can be placed at a specified location by the second operating system after the software is installed successfully.

In a specific implementation, when some application or software is no longer needed, the terminal can perform a delete operation on the terminal; however, software uninstall, cache data removal is finally performed in the first operating system in the server. After the software is uninstalled in the first operating system, the server can send an uninstall result to the terminal, as a consequence, the uninstall result displayed in the second operating system is that the software icon of the uninstalled software will no longer appear.

Optionally, reference can also be made to FIG. 2e; the server of the embodiment of the present disclosure can further include the fourth receiving unit 210, and is configured to store the terminal information that the terminal has synchronized during the shutdown process of the terminal, so as to ensure the security of the terminal information.

The fourth receiving unit 210 is configured to receive terminal information from the terminal, among which the terminal information includes the terminal identifier and information of the second operating system of the terminal, and the terminal information is sent by the terminal during the shutdown process; the updating unit 22 is further configured to update the first operating system on the server according to the terminal information.

In a specific implementation, the terminal information sent to the server can include the terminal identifier, a list of all software on the second operating system, and the current display effect; the server will synchronize the terminal information to the first operating system.

In the technical solution of the present disclosure, system or software problems can be user feedback to manufacturers based on user experience, or it can also be found by monitoring the operating efficiency of the first operating system and the second operating system. When a problem is identified, manufactures can perform real-time remediation with regard to this problem via a specified interface, or, when a new operating system is released for the terminal, the server can upgrade the first operating system according to the new operating system, thereafter, send an upgrade result to the terminal so as to display through the second operating system. Besides, if the first operating system itself has an upgrade event or the software in the first operating system has an upgrade event, when the update result is sent, or when the terminal first connects to the server after a system upgrade, the user can be prompted that the current terminal has been updated, and the updated items will be shown clearly.

The server of the embodiment of the present disclosure improves user experience and makes it easy and convenient for the user to upgrade the terminal operating system; in particular, the server can be used for the operating system of mobile terminals commonly used by users, the server according to the embodiment of the present disclosure achieves the effect of saving traffic, saving updating time, and updating the operating system in time. The server of the embodiment of the present disclosure can better support the terminal to update the operating system data in time, therefore, improve the operating system data update efficiency of the terminal, improve the operating system security and stability of the terminal, reduce the time cost of users, and improve user experience.

According to an embodiment of the present disclosure, it is provided a method for a terminal to update an operating system, which includes: an update result is received from a server, and the update result is generated after the server has updated a first operating system corresponding to a terminal identifier of a terminal according to system update information; and the update result is displayed on a second operating system of the terminal.

In the following, the technical solutions of the present disclosure will be described in detail with reference to the accompanying drawings and specific embodiments.

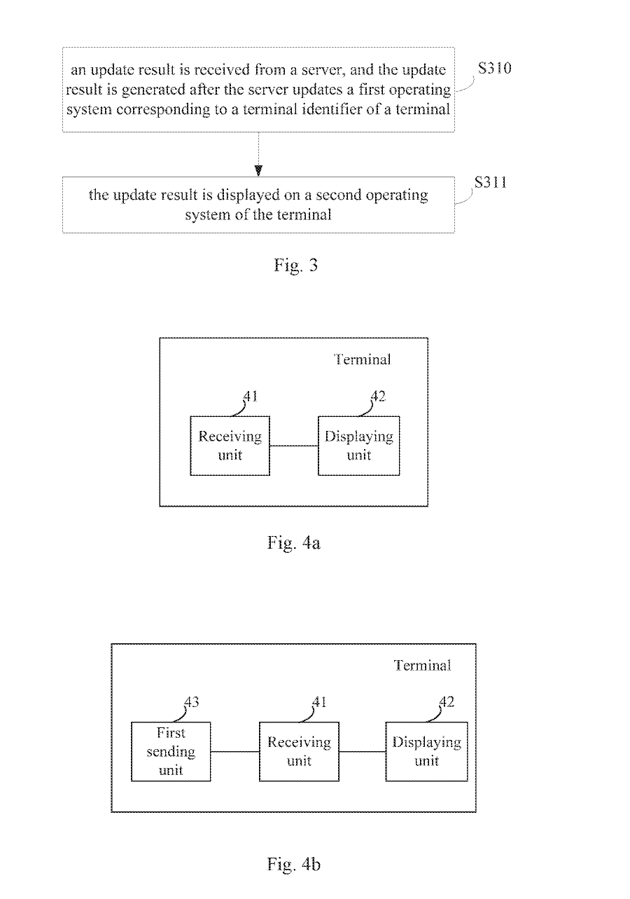

As illustrated in FIG. 3, the method for a terminal to update an operating system according to the embodiment of the present disclosure can include the following steps.

S310, an update result is received from a server, and the update result is generated after the server has updated a first operating system corresponding to a terminal identifier of a terminal.

S311, the update result is displayed on a second operating system of the terminal.

In the embodiment of the present disclosure, the terminal used by user is improved and the server for maintaining the terminal is also improved, therefore, the terminal can keep the best update state without an upgrading package. In a specific implementation, in the method of the embodiment of the present disclosure, the server is provided with multiple subsystems corresponding to the operating system of the terminal, that is, the first operating system arranged on the server corresponds to the second operating system of the terminal.

Further, the first operating system on the server contains complete applications of all kinds of software and various factory default software, which is configured to receive data transmitted by the terminal, execute instructions, and provide background services for the terminal. The second operating system on the terminal used by user is a simple operating system, and is configured to carry out data interaction with the server; the second operating system includes drivers of terminal hardware and cache and is used as user equipment, and is configured to transmit operation contents and operation instructions of the user to the server, request the server to support to execute the operation instructions or synchronize the operation contents. Connections between the server and the terminal are usually network connections, such as the Internet, local area network, and the like.

In a specific implementation, after the maintenance staff has improved the operating mode of the terminal according to user feedback on the terminal as well as self-test instruction execution efficiency, maintenance operations of the system will be reflected in the first operating system of the server, that is, system data and application data in the first operating system of the server will be maintained and updated, finally, the result of the maintenance and upgrade is sent to the terminal for display to the user, for example, the user can directly see the improvement of the icon, the page optimization and indirectly feel the effect of increasing the rate of reaction progress. Since the update result is pushed to the terminal, the terminal does not need to install an upgrade package and the like, and the improvement effect as a result of upgrading the first operating system by the server can be reflected in the second operating system of the terminal, therefore, compared with the related art, the technical solution of the embodiment of the present disclosure can greatly reduce the consumption of network traffic, solve problems that the terminal memory is occupied and the system cannot be upgraded in a timely manner, and improve the operating stability of the first operating system and the second operating system, users can experience the upgraded system immediately and directly through the terminal.

In a specific implementation, the terminal always keep in sync with the second operating system on the server in terms of software and display; when the user add/delete applications to the terminal, use the application, or modify the terminal display, the terminal can feed back the operation contents of the user to the server, whereby the first operating system of the server can make corresponding changes synchronously. When the server upgrades the first operating system, interface improvements of the first operating system can be synchronized to the terminal, such that the terminal can update according to the result transmitted by the server. Besides, applications that run on the first operating system on the server and interface display are based on the status before the terminal is shut down.

In a specific implementation, the terminal identifier can be a unique identifier, such as machine serial number, Media Access Control (MAC) address, or an account registered in the system; when the terminal needs to send information to the server, the information sent can carry the terminal identifier for the server to record and categorize; when the server needs to detect whether the terminal needs to be upgraded, the server can find the first operating system corresponding to the terminal through the terminal identifier recorded.

Optionally, the terminal according to the embodiment of the present disclosure can be configured to generate an execution instruction according to operation contents of the user on the terminal and send the execution instruction to the server, whereby the server can execute the execution instruction, and an execution result of the execution instruction by the server can be displayed: an execution instruction is sent to the server whereby the server can execute the execution instruction on the first operating system, among which the execution instruction is an instruction generated by the terminal according to operation contents of the user on the terminal; an execution result is received from the server, and the execution result is generated after the execution instruction is executed on the first operating system by the server; the execution result is displayed on a second operating system of the terminal.

In a specific implementation, the execution instruction sent by the terminal can be generated according to a page entry instruction, searching keywords based on the browser, and other user operations; at this point, after the execution instruction is sent to the server by the terminal, the server can cause the first operating system to execute the execution instruction, and return an execution result (for example, the page entered, search results) to the terminal for display to the user through a second operating system.

Optionally, the above-mentioned execution instruction can carry pending data (in other words, data to be processed) and a software identifier of software required to be invoked to process the pending data, among which the pending data can include data collected by a hardware device of the terminal, and correspondingly, the execution result feedback from the server can include process result data, which is generated by the server after the pending data is processed by software corresponding to the software identifier of the first operating system.

In a specific implementation, the execution instruction can carry pending data, for example, a manufacture-provided photographic application; when the icon of the photographic application on the terminal is clicked by user, the terminal can initiate a hardware invoking program to cause a camera to take pictures, after the photographing is completed, a photograph processing command carrying shooting data is transmitted to the server, such that the first operating system of the server can process the shooting data, generate image data for display, and sent the image data to the terminal, whereby the terminal can display the image data. In the execution of the execution instruction, the main body that is actually used to execute the execution instruction is the server, therefore, even if a large number of calculation contents is involved, it will not take up the memory of the terminal, pauses will not occur during the execution of this execution instruction. The pending data carried in the execution instruction of the present embodiment is not limited to the shooting data, it can also be some gravity sensing data, infrared Bluetooth frequency data, and so on, and the present disclosure is not limited thereto.

Optionally, the terminal according to the embodiment of the present disclosure is further configured to generate a software install request according to install operation contents of the user on the terminal and send the software install request to the server, whereby the server can install software selected by user on the first operating system, and send an install result to the terminal: a software install request is sent to the server; an installation result is received from the server, and the installation result is generated after the software to be installed as indicated by the software install request is installed on the first operating system by the server; the installation result is displayed on the second operating system.

In a specific implementation, according to the operation contents of the user, when it is needed to provide more applications to the user, the terminal can send the software install request to the server, whereby the server can obtain data of the software to be installed and install the same of the first operating system; at the end, the installation result (such as a new icon, a page entered by clicking the icon, and so on) after software installation is sent to the terminal for display. When the user uses the installed software, the terminal can send the operation contents of the user based on the software to the server for process. As can be seen, the installation is actually performed by the server and the storage location of the installer is the server either, thus, the operation contents of installing software by user will not take up the memory of the terminal, and therefore, it will not slow down the speed of the terminal.

In a specific implementation, when the new software is installed by the first operating system, the terminal should have a new software icon appears in the terminal interface, and the display location of the new software icon can be specified by the first operating system or can be pre-determined by the second operating system; if the display location of the new icon is pre-determined by the second operating system before the software install request is submitted by the terminal, the display location of the new software icon can be submitted to the server along with the software install request by the terminal, whereby the new software icon can be placed at a specified location by the second operating system after the software is installed successfully.

Optionally, the terminal according to the embodiment of the present disclosure can be further configured to generate a software uninstall request according to uninstall operation contents of the user on the terminal and send the software uninstall request to the server, whereby the server can uninstall software as indicated by user in the first operating system and send an uninstall result to the terminal: a software uninstall request is sent to the server; an uninstall result is received from the server, and the uninstall result is generated after the software to the uninstalled as indicated by the software uninstall request is uninstalled on the first operating system by the server; and the uninstall result is displayed on the second operating system.

In a specific implementation, when some application or software is no longer needed, a delete operation of the user on the terminal can be detected by the terminal; however, software uninstall, cache data removal is finally performed in the first operating system in the server. After the software is uninstalled in the first operating system, the server can send an uninstall result to the terminal, as a consequence, the uninstall result displayed in the second operating system is that the software icon of the uninstalled software will no longer appear.

Optionally, during the shutdown process of the terminal, the terminal can send terminal information to the server, whereby the server can store the terminal information synchronized from the terminal, so as to ensure the security of the terminal information: terminal information is sent to the server when shutdown process is performed at the terminal, among which the terminal information includes the terminal identifier and information of the second operating system of the terminal, whereby the server can update the first operating system according to the terminal information.

In a specific implementation, the terminal information sent to the server by the terminal can include the terminal identifier, a list of all software on the second operating system, and the current display effect; the server will synchronize the terminal information to the first operating system.

In the technical solution of the present disclosure, system or software problems can be user feedback to manufacturers based on user experience, or it can also be found by monitoring the operating efficiency of the first operating system and the second operating system. When a problem is identified, manufactures can perform real-time remediation with regard to this problem via a specified interface, or, when a new operating system is released for the terminal, the terminal of the embodiment of the present disclosure can accept the update result from the server directly, and the update result is displayed to achieve the effect of updating the operating system; the update operation is actually performed by the server, the server can upgrade the first operating system according to a new operating system and send the upgrade result to the terminal for display by the second operating system. Besides, if the first operating system itself has an upgrade event or the software in the first operating system has an upgrade event, when the update result is sent, or when the terminal first connects to the server after a system upgrade, the terminal can prompt the user that the current terminal has been updated, and the updated items will be shown clearly.

The method of the embodiment of the present disclosure improves user experience and makes it easy and convenient for the user to upgrade the terminal operating system; in particular, for mobile terminals commonly used by users, the method according to the embodiment of the present disclosure achieves the effect of saving traffic, saving updating time, and updating the operating system in time. The embodiment of the present disclosure improves the system update mode of the terminal, by receiving the update result of the first operating system on the server and then displaying the update result on the second operating system of the terminal, the update efficiency of the operating system of the terminal is improved. The embodiment of the present disclosure can update operating system data in a timely manner, therefore, the operating system of the terminal can have good security and stability, and it is possible to reduce the time cost for the user to update the terminal and to improve user experience.

Correspondingly, according to an embodiment of the present disclosure, it is provided a terminal, which can be used to implement the method for a terminal to update an operating system. The terminal can include: a receiving unit, configured to receive an update result from a server, and the update result is generated after the server has updated a first operating system corresponding to a terminal identifier of a terminal; and a displaying unit, configured to display the update result on a second operating system of the terminal. The terminal according to the embodiment of the present disclosure has good security and stability and is able to update operating system data in a timely manner, reduce the time cost for the user to update the terminal, and improve user experience.

In the following, the technical solutions of the present disclosure will be described in detail with reference to the accompanying drawings and specific embodiments.

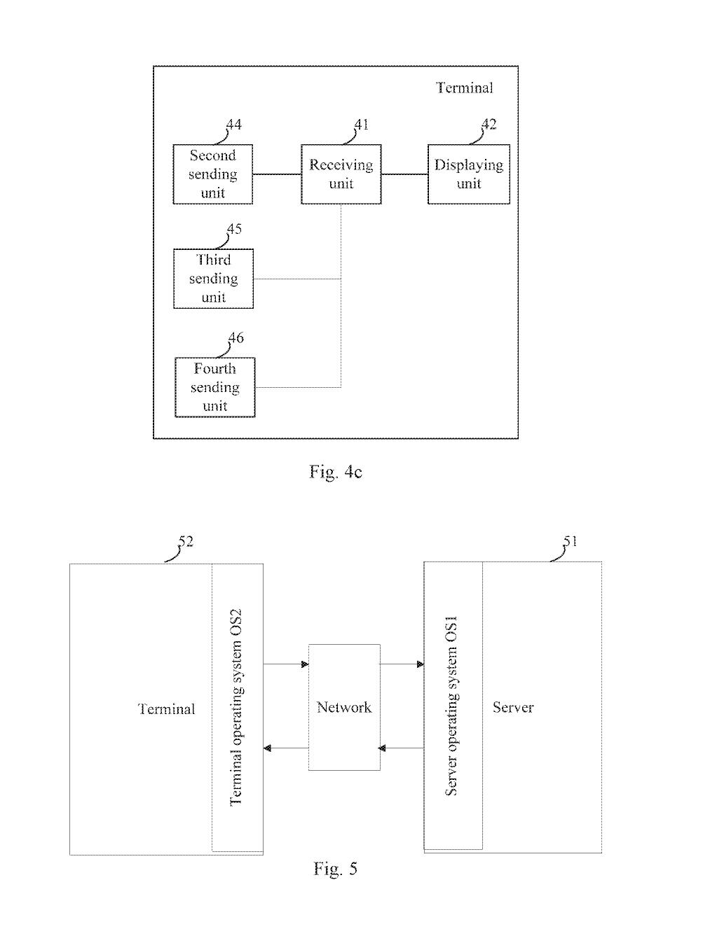

FIG. 4a is a schematic diagram illustrating the structure of a terminal according to an embodiment of the present disclosure. The apparatus of this embodiment can be used to carry out the method illustrated in FIG. 3. In particular, the apparatus of this embodiment includes a receiving unit 41 and a displaying unit 42, reference can also be made to FIG. 4b and FIG. 4c, the terminal of the embodiment of the present disclosure can further include a first sending unit 43, a second sending unit 44, a third sending unit 45, and a fourth sending unit 46.

The receiving unit 41 is configured to receive an update result from a server, and the update result is generated after a first operating system corresponding to a terminal identifier is updated by the server according to system updating information.

The displaying unit 42 is configured to display the update result on the second operating system of the terminal.

In the embodiment of the present disclosure, the terminal used by user is improved and the server for maintaining the terminal is also improved, therefore, the terminal can keep the best update state without an upgrading package. In a specific implementation, in the method of the embodiment of the present disclosure, the server is provided with multiple subsystems corresponding to the operating system of the terminal, that is, the first operating system arranged on the server corresponds to the second operating system of the terminal.

Further, the first operating system on the server contains complete applications of all kinds of software and various factory default software, which is configured to receive data transmitted by the terminal, execute instructions, and provide background services for the terminal. The second operating system on the terminal used by user is a simple operating system, and is configured to carry out data interaction with the server; the second operating system includes drivers of terminal hardware and cache and is used as user equipment, and is configured to transmit operation contents and operation instructions of the user to the server, request the server to support to execute the operation instructions or synchronize the operation contents. Connections between the server and the terminal are usually network connections, such as the Internet, local area network, and the like.

In a specific implementation, after the maintenance staff has improved the operating mode of the terminal according to user feedback on the terminal as well as self-test instruction execution efficiency, maintenance operations of the system will be reflected in the first operating system of the server, that is, system data and application data in the first operating system of the server will be maintained and updated, finally, the result of the maintenance and upgrade is sent to the terminal for display to the user, for example, the user can directly see the improvement of the icon, the page optimization and indirectly feel the effect of increasing the rate of reaction progress. Since the update result is pushed to the terminal, the terminal does not need to install an upgrade package and the like, and the improvement effect as a result of upgrading the first operating system by the server can be reflected in the second operating system of the terminal, therefore, compared with the related art, the technical solution of the embodiment of the present disclosure can greatly reduce the consumption of network traffic, solve problems that the terminal memory is occupied and the system cannot be upgraded in a timely manner, and improve the operating stability of the first operating system and the second operating system, users can experience the upgraded system immediately and directly through the terminal.

In a specific implementation, the terminal always keep in sync with the second operating system on the server in terms of software and display; when the user add/delete applications to the terminal, use the application, or modify the terminal display, the terminal can feed back the operation contents of the user to the server, whereby the first operating system of the server can make corresponding changes synchronously. When the server upgrades the first operating system, interface improvements of the first operating system can be synchronized to the terminal, and the terminal will update according to the result transmitted by the terminal. Besides, applications that run on the first operating system on the server and interface display are based on the status before the terminal is shut down.

In a specific implementation, the terminal identifier can be a unique identifier, such as machine serial number, Media Access Control (MAC) address, or an account registered in the system; when the terminal needs to send information to the server, the information sent can carry the terminal identifier for the server to record and categorize; when the server needs to detect whether the terminal needs to be upgraded, the server can find the first operating system corresponding to the terminal through the terminal identifier recorded.

Optionally, reference can also be made to FIG. 4b; the terminal can also be supported by the server via the first sending unit 43, the receiving unit 41, and the displaying unit 42, so as to response to operation contents of the user on the terminal.

The first sending unit 43 is configured to send an execution instruction to the server, whereby the server can execute the execution instruction on the first operating system, among which the execution instruction is an instruction generated by the terminal according to the operation contents of the user on the terminal.

The receiving unit 41 is further configured to receive an execution result from the server, and the execution result is generated after the server executes the execution instruction on the first operating system.

The displaying unit 42 is further configured to display the execution result on the second operating system.

In specific implementation, the execution instruction sent by the first sending unit 43 can be generated according to a page entry instruction, searching keywords based on the browser, and other user operations; after the execution instruction is sent to the server by the terminal by the first sending unit 43, the server can cause the first operating system to execute the execution instruction, and return an execution result (for example, the page entered, search results) to the terminal, and then the displaying unit 42 can display the execution result to the user through a second operating system of the terminal.

Optionally, the above-mentioned execution instruction can carry pending data (in other words, data to be processed) and a software identifier of software required to be invoked to process the pending data, among which the pending data can include data collected by a hardware device of the terminal, and correspondingly, the execution result feedback from the server can include process result data, which is generated by the server after the pending data is processed by software corresponding to the software identifier of the first operating system.

In a specific implementation, the execution instruction can carry pending data, for example, a manufacture-provided photographic application; when the icon of the photographic application on the terminal is clicked by user, the terminal can initiate a hardware invoking program to cause a camera to take pictures, after the photographing is completed, a photograph processing command carrying shooting data is transmitted to the server, such that the first operating system of the server can process the shooting data, generate image data for display, and sent the image data to the terminal, whereby the terminal can display the image data. In the execution of the execution instruction, the main body that is actually used to execute the execution instruction is the server, therefore, even if a large number of calculation contents is involved, it will not take up the memory of the terminal, pauses will not occur during the execution of this execution instruction. The pending data carried in the execution instruction of the present embodiment is not limited to the shooting data, it can also be some gravity sensing data, infrared Bluetooth frequency data, and so on, and the present disclosure is not limited thereto.

Optionally, reference can also be made with reference to FIG. 4c, the terminal of the embodiment of the present disclosure can be supported by the server so as to response to the operation contents of the user of installing software.

The second sending unit 44 is configured to send a software install request to the server.

The receiving unit 41 is further configured to receive an install result from the server, and the install result is generated after software to be installed as indicated by the software install request is installed on the first operating system by the server.

The displaying unit 42 is further configured to display the install result on the second operating system.

In a specific implementation, according to the operation contents of the user, when it is needed to provide more applications to the user, the terminal can send the software install request to the server, whereby the server can obtain data of the software to be installed and install the same of the first operating system; at the end, the installation result (such as a new icon, a page entered by clicking the icon, and so on) after software installation is sent to the terminal for display. When the user uses the installed software, the terminal can send the operation contents of the user based on the software to the server for process. As can be seen, the installation is actually performed by the server and the storage location of the installer is the server either, thus, the operation contents of installing software by user will not take up the memory of the terminal, and therefore, it will not slow down the speed of the terminal.

In a specific implementation, when the new software is installed by the first operating system, the terminal should have a new software icon appears in the terminal interface, and the display location of the new software icon can be specified by the first operating system or can be pre-determined by the second operating system; if the display location of the new icon is pre-determined by the second operating system before the software install request is submitted by the terminal, the display location of the new software icon can be submitted to the server along with the software install request by the terminal, whereby the new software icon can be placed at a specified location by the second operating system after the software is installed successfully.

Optionally, reference can also be made with reference to FIG. 4c; the terminal of the embodiment of the present disclosure can be supported by the server so as to response to the operation contents of the user of uninstalling software.

The third sending unit 45 is further configured to send a software uninstall request to the server.

The receiving unit 41 is configured to receive an uninstall result from the server, and the uninstall result is generated after the software to the uninstalled as indicated by the software uninstall request is uninstalled on the first operating system by the server; and the uninstall result is displayed on the second operating system.

The displaying unit 42 is configured to display the uninstall result on the second operating system.

In a specific implementation, when some application or software is no longer needed, a delete operation of the user on the terminal can be detected by the terminal; however, software uninstall, cache data removal is finally performed in the first operating system in the server. After the software is uninstalled in the first operating system, the server can send an uninstall result to the terminal, as a consequence, the uninstall result displayed in the second operating system is that the software icon of the uninstalled software will no longer appear.

Optionally, reference can also be made with reference to FIG. 4c; the terminal of the embodiment of the present disclosure can be supported by the server so as to synchronize the terminal information to the first operating system of the server prior to shut down of the terminal, so as to ensure the security of the terminal information.

The fourth sending unit 46 is further configured to send terminal information to the server when shutdown process is performed at the terminal, among which the terminal information includes the terminal identifier and information of the second operating system of the terminal, whereby the server can update the first operating system according to the terminal information.

In a specific implementation, the terminal information sent to the server by the terminal can include the terminal identifier, a list of all software on the second operating system, and the current display effect; the server will synchronize the terminal information to the first operating system.

In the technical solution of the present disclosure, system or software problems can be user feedback to manufacturers based on user experience, or it can also be found by monitoring the operating efficiency of the first operating system and the second operating system. When a problem is identified, manufactures can perform real-time remediation with regard to this problem via a specified interface, or, when a new operating system is released for the terminal, the terminal of the embodiment of the present disclosure can accept the update result from the server directly, and the update result is displayed to achieve the effect of updating the operating system; the update operation is actually performed by the server, the server can upgrade the first operating system according to a new operating system and send the upgrade result to the terminal for display by the second operating system. Besides, if the first operating system itself has an upgrade event or the software in the first operating system has an upgrade event, when the update result is sent, or when the terminal first connects to the server after a system upgrade, the terminal can prompt the user that the current terminal has been updated, and the updated items will be shown clearly.

The terminal of the embodiment of the present disclosure improves user experience and makes it easy and convenient for the user to upgrade the terminal operating system; in particular, it can be used to update the operating system of mobile terminals commonly used by users, the terminal according to the embodiment of the present disclosure achieves the effect of saving traffic, saving updating time, and updating the operating system in time. Compared with the related art, the terminal of the embodiment of the present disclosure improves the system update mode of the terminal, by receiving the update result of the first operating system on the server and then displaying the update result on the second operating system of the terminal, the update efficiency of the operating system of the terminal is improved. The embodiment of the present disclosure can update operating system data in a timely manner, therefore, the operating system of the terminal can have good security and stability, and it is possible to reduce the time cost for the user to update the terminal and to improve user experience.

Correspondingly, a system for implement the technical solution of FIG. 1 and FIG. 3 is provided according to an embodiment of the present disclosure. Reference can also be made with reference to FIG. 5, as illustrated in FIG. 5, the system of the embodiment of the present disclosure includes a serve 51 and a terminal 52, among which the server 51 and the terminal 52 are connected via a network, and the terminal 52 can be a mobile terminal equipped with a terminal operating system OS2; the server 51 is equipped with a server operating system OS1 corresponding to a terminal identifier. The OS1 system can support the OS2 system well, and is used to process data, save data, and provide upgrade services. The OS2 system can be used to display the improvement result of the OS1 system to the user, such that the terminal used by user is always in the best update status, and user experience can be improved.

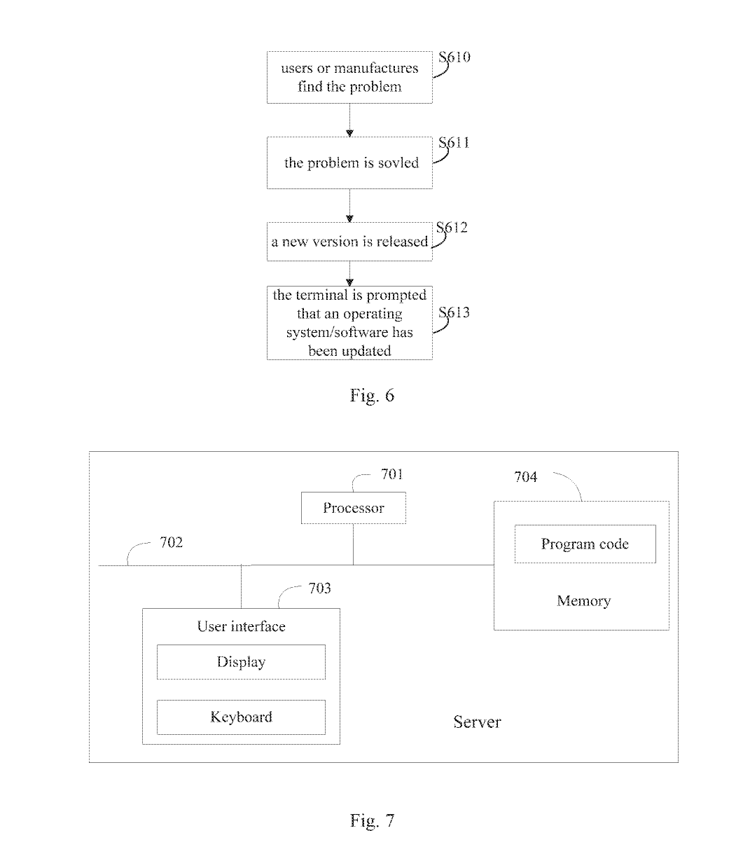

As illustrated in FIG. 6, manners to improve the terminal operating system by manufactures can include: solutions can be proposed based on user feedback as well as problems found by the manufacturers and a new upgraded version can be provided; the main body for version upgrade is the server, and the device to reflect the version upgrade is the terminal, when the system has been upgraded, the server will prompt that the terminal software or system has been updated.

The system of the embodiment of the present disclosure improves the terminal updating scheme, so that the terminal can always update the operating system data in time; in this way, the update efficiency of data of the terminal operating system can be improved, the security and stability of the terminal operating system can be improved, the time cost of users can be reduced, and user experience can be improved.

FIG. 7 is a structural diagram illustrating a server according to another embodiment of the present disclosure. As illustrated in FIG. 7, the server can include: at least one processor 701 such as a CPU, at least one user interface 703, a memory 704, at least one communication bus 702. The communication bus 702 is used to implement connection communication between these components. The user interface 703 can include Display, Keyboard; optionally, the user interface 703 can include a standard wired interface or wireless interface. The storage 704 can be a high speed RAM memory or a non-volatile memory such as disk storage. The memory 704 can alternatively be at least one memory device located remote from the processor 701. The processor 701 can be illustrated in connection with the server described in FIGS. 2a, 2b, 2c, 2d and 2e. The memory 704 is configured to store a set of program code, and the processor 701 is configured to invoke the program code stored in the memory 704 to perform the follows.

A terminal identifier that needs to update an operating system is acquired; a first operating system corresponding to the terminal identifier on a server is updated according to system update information; and an update result of the first operating system is sent to a terminal corresponding to the terminal identifier, so that a second operating system of the terminal displays the update result.

In an alternative embodiment, after the processor 701 invokes the program code stored in the memory 704 to send the update result of the first operating system to a terminal corresponding to the terminal identifier, the follows can be performed.

An execution instruction sent from the terminal, among which the execution instruction is an instruction generated by the terminal according to operation contents of the user on the terminal; the execution instruction is executed on the first operating system; an execution result of the first operating system is sent to the terminal, so that a second operating system of the terminal can display the execution result.

In an alternative embodiment, the above-mentioned execution instruction can carry pending data (in other words, data to be processed) and a software identifier of software required to be invoked to process the pending data; the process that the processor 701 invokes the program code stored in the memory 704 to execute the execution instruction on the first operating system can be implemented as follows.

The pending data is acquired; software corresponding to the software identifier of the first operating system is used to process the pending data, and process result data is generated; the update result of the first operating system is sent to the terminal corresponding to the terminal identifier, which can include: the process result data is sent to the terminal, so that the terminal can display the result data in the second operating system.

In an alternative embodiment, after the processor 701 invokes the program code stored in the memory 704 to send the update result of the first operating system to the terminal corresponding to the terminal identifier, the follows can be performed.

A software install request is received from the terminal; software to be installed as indicated by the software install request is acquired; the software to be installed is installed in the first operating system corresponding to the terminal identifier; an installation result of the first operating system is transmitted to the terminal, so that the terminal can display the installation result on the second operating system.

Alternatively, a software uninstall request carrying the identifier of the software to be uninstalled is received from the terminal; the software to be uninstalled corresponding to the identifier is uninstalled from the first operating system corresponding to the terminal identifier in the server; an uninstall result of the first operating system is sent to the terminal, so that the second operating system of the terminal can display the uninstall result.

In an alternative embodiment, after the processor 701 invokes the program code stored in the memory 704 to send the update result of the first operating system to the terminal corresponding to the terminal identifier, the follows can be performed.

Terminal information is received from the terminal, among which the terminal information includes the terminal identifier and information of the second operating system of the terminal, and the terminal information is sent by the terminal during the shutdown process; and the first operating system on the server is updated according to the terminal information.

Specifically, the server illustrated herein can implement all or part of the procedures of the text information display method embodiment described in connection with FIG. 1, FIG. 2, or FIG. 7.

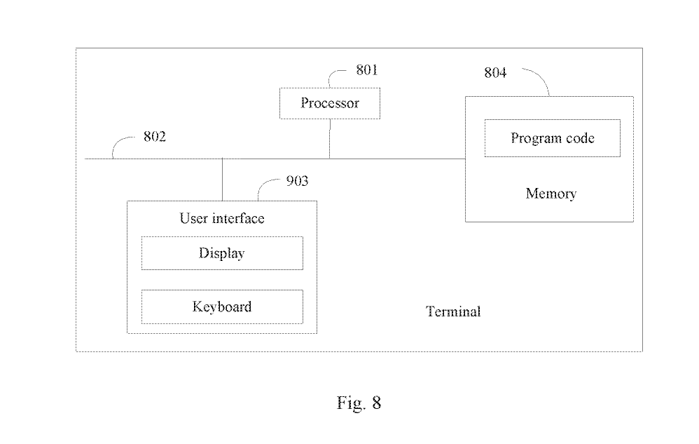

FIG. 8 is a structure diagram illustrating another terminal according to another embodiment of the present disclosure. As illustrated in FIG. 8, the terminal can include: at least one processor 801 such as a CPU, at least one user interface 803, a memory 804, at least one communication bus 802. The communication bus 802 is used to implement connection communication between these components. The user interface 803 can include Display, Keyboard; optionally, the user interface 803 can include a standard wired interface or wireless interface. The storage 804 can be a high speed RAM memory or a non-volatile memory such as disk storage. The memory 804 can alternatively be at least one memory device located remote from the processor 801. The processor 801 can be illustrated in connection with the server described in FIGS. 4a, 4b, and 4e. The memory 804 is configured to store a set of program code, and the processor 801 is configured to invoke the program code stored in the memory 804 to perform the follows.

An update result is received from a server, and the update result is generated after the server has updated a first operating system corresponding to a terminal identifier of a terminal according to system update information; and the update result is displayed on a second operating system of the terminal.

In an alternative embodiment, after the processor 801 invokes the program code stored in the memory 804 to display the update result on the second operating system, the follows can be performed.

An execution instruction is sent to the server, whereby the server can execute the execution instruction on the first operating system, among which the execution instruction is an instruction generated by the terminal according to operation contents of the user on the terminal; an execution result is received from the server, and the execution result is generated after the execution instruction is executed on the first operating system by the server; the execution result is displayed on a second operating system of the terminal.

In an alternative embodiment, the execution instruction can carry pending data and a software identifier of software required to be invoked to process the pending data.

The execution result includes process result data which is generated by the server after the pending data is processed by software corresponding to the software identifier of the first operating system.

In an alternative embodiment, after the processor 801 invokes the program code stored in the memory 804 to display the update result on the second operating system, the follows can be performed.

A software install request is sent to the server; an installation result is received from the server, and the installation result is generated after the software to be installed as indicated by the software install request is installed on the first operating system by the server; the installation result is displayed on the second operating system.

Alternatively, a software uninstall request is sent to the server; an uninstall result is received from the server, and the uninstall result is generated after the software to the uninstalled as indicated by the software uninstall request is uninstalled on the first operating system by the server; and the uninstall result is displayed on the second operating system.

In an alternative embodiment, after the processor 801 invokes the program code stored in the memory 804 to display the update result on the second operating system, the follows can be performed.

Terminal information is sent to the server when shutdown process is performed at the terminal, among which the terminal information includes the terminal identifier and information of the second operating system of the terminal, whereby the server can update the first operating system according to the terminal information.

Specifically, the terminal illustrated herein can implement all or part of the procedures of the text information display method embodiment described in connection with FIG. 1, FIG. 2, or FIG. 6.

In the above-described embodiments, the descriptions of the respective embodiments are each focused, and a portion not described in detail in one embodiment can be found in the description of other embodiments. It will also be appreciated by those skilled in the art that the embodiments described in the specification belong to the exemplary embodiments, and the actions and units involved are not necessarily required for embodiments of the present disclosure.

The steps in the method according to the embodiment of the present disclosure can be sequentially adjusted, merged and subtracted according to actual needs.

The units in the device of the embodiment of the present disclosure can be combined, divided and deleted according to actual needs.

The units in the embodiments of the present disclosure can be achieved through integrated circuits such as CPU or Application Specific Integrated Circuit (ASIC).

It will be understood by those of ordinary skill in the art that all or some of the steps in the method of the embodiments described above may be accomplished by a computer program instructing the associated hardware, the program may be stored in a computer-readable storage medium which, when executed, may include a flow of an embodiment of the method as described above. The storage medium may be a magnetic disk, an optical disk, a Read-Only Memory (ROM), or a Random Access Memory (RAM).

The above disclosure is only exemplary embodiments of the present disclosure, and the scope of the present disclosure cannot be limited thereby; therefore, equivalent variations according to the claims of the present disclosure still fall within the scope of the present disclosure.

1. A method for a terminal to update an operating system, comprising:
acquiring a terminal identifier that needs to update an operating system;
updating a first operating system corresponding to the terminal identifier on a server according to system update information; and
sending an update result of the first operating system to a terminal corresponding to the terminal identifier, so that a second operating system of the terminal displays the update result.

2. The method of claim 1, wherein after sending the update result of the first operating system to the terminal corresponding to the terminal identifier, the method further comprises:
receiving an execution instruction sent from the terminal, wherein the execution instruction is an instruction generated by the terminal according to operation contents of a user on the terminal;
executing the execution instruction on the first operating system; and
sending an execution result of the first operating system to the terminal, so that the second operating system of the terminal displays the execution result.

3. The method of claim 2,
wherein the execution instruction carries pending data and a software identifier of software required to be invoked to process the pending data;
wherein executing the execution instruction on the first operating system comprises:
acquiring the pending data;
processing the pending data by software corresponding to the software identifier on the first operating system, and generating process result data;
wherein sending the update result of the first operating system to the terminal corresponding to the terminal identifier comprises:
sending the process result data to the terminal, so that the terminal displays the process result data on the second operating system.

4. The method of claim 1, wherein after sending the update result of the first operating system to the terminal corresponding to the terminal identifier, the method further comprises:
receiving a software install request sent from the terminal;
acquiring software to be installed as indicated by the software install request;
installing the software to be installed on the first operating system corresponding to the terminal identifier;
sending an install result of the first operating system to the terminal, so that the second operating system of the terminal displays the install result.

5. The method of claim 1, wherein after sending the update result of the first operating system to the terminal corresponding to the terminal identifier, the method further comprises:
receiving terminal information sent from the terminal, wherein the terminal information comprises the terminal identifier and information of the second operating system on the terminal, and the terminal information is sent when a shutdown operation is performed by the terminal; and
updating the first operating system on the server according to the terminal information.

6. (canceled)

7. (canceled)

8. (canceled)

9. (canceled)

10. (canceled)

6. A method for a terminal to update an operating system, comprising:
receiving an update result sent from a server, wherein the update result is generated after the server updates a first operating system corresponding to a terminal identifier according to system update information; and
displaying the update result on a second operating system, wherein the second operating system exists on the terminal.

7. The method of claim 6, wherein after displaying the update result on the second operating system, the method further comprises:
sending an execution instruction to the server, so that the server executes the execution instruction on the first operating system, wherein the execution instruction is an instruction generated by the terminal according to operation contents of a user on the terminal;
receiving an execution result sent from the server, wherein the execution result is generated after the execution instruction is executed on the first operating system by the server; and
displaying the execution result on the second operating system.

8. The method of claim 7, wherein
the execution instruction carries pending data and a software identifier of software required to be invoked to process the pending data; and
the execution result comprises process result data, wherein the process result data is generated after the server processes the pending data through the software corresponding to the software identifier on the first operating system.

9. The method of claim 6, wherein after displaying the update result on the second operating system, the method further comprises:
sending a software install request to the server;
receiving an install result sent from the server, wherein the install result is generated after the server installs the software to be installed as indicated by the software install request on the first operating system; and
displaying the install result on the second operating system.

10. The method of claim 6, wherein after displaying the update result on the second operating system, the method further comprises:
sending terminal information to the server when a shutdown operation is performed by the terminal, wherein the terminal information comprises the terminal identifier and information of the second operating system on the terminal, whereby the server updates the first operating system according to the terminal information.

11. A terminal, comprising:
a processor;
a memory configured to store a set of program code, wherein the processor is configured to invoke the program code stored in the memory to perform the components of:
a receiving unit, configured to receive an update result sent from a server, wherein the update result is generated after the server updates a first operating system corresponding to a terminal identifier of the terminal according to system update information; and
a displaying unit, configured to display the update result on a second operating system, wherein the second operating system exists on the terminal.

12. The terminal of claim 11, wherein the processor is further configured to invoke the program code stored in the memory to perform the components of:
a first sending unit, configured to send an execution instruction to the server, so that the server executes the execution instruction on the first operating system, wherein the execution instruction is an instruction generated by the terminal according to operation contents of a user on the terminal;
the receiving unit is further configured to receive an execution result sent from the server, wherein the execution result is generated after the server executes the execution instruction on the first operating system; and
the displaying unit is further configured to display the execution result on the second operating system.

13. The terminal of claim 11, wherein
the execution instruction carries pending data and a software identifier of software required to be invoked to process the pending data; and
the execution result comprises process result data, wherein the process result data is generated after the server processes the pending data through the software corresponding to the software identifier on the first operating system.

14. The terminal of claim 11, wherein the processor is further configured to invoke the program code stored in the memory to perform the components of:
a second sending unit, configured to send a software install request to the server; and
the receiving unit is further configured to receive an install result sent from the server, wherein the install result is generated after the server installs the software to be installed as indicated by the software install request on the first operating system; and
the displaying unit is further configured to display the install result on the second operating system.

20. (canceled)

15. The terminal of claim 11, wherein the processor is further configured to invoke the program code stored in the memory to perform the components of:
a third sending unit, configured to send a software uninstall request to the server;
the receiving unit is further configured to receive an uninstall result sent from the server, wherein the uninstall result is generated after the server uninstalls the software to be uninstalled as indicated by the software uninstall request on the first operating system; and
the displaying unit is further configured to display the uninstall result on the second operating system.

16. The terminal of claim 11, wherein the processor is further configured to invoke the program code stored in the memory to perform the components of:
a fourth sending unit, configured to send terminal information to the server when a shutdown operation is performed by the terminal, wherein the terminal information comprises the terminal identifier and information of the second operating system, whereby the server updates the first operating system according to the terminal information.

17. The method of claim 6, wherein after sending the update result of the first operating system to the terminal corresponding to the terminal identifier, the method further comprises:
receiving a software uninstall request sent from the terminal, wherein the software uninstall request carries an identifier of software to be uninstalled;
uninstalling the software to be uninstalled corresponding to the identifier of the software to be uninstalled from the first operating system corresponding to the terminal identifier in the server; and
sending an uninstall result of the first operating system to the terminal, so that the second operating system of the terminal displays the uninstall result.
